(19) United States
(12) Patent Application Publication
(10) Pub. No.: US 2008/0217454 A1
(43) Pub. Date: Sep. 11, 2008

(54) TAPE DRIVE

(76) Inventor: Bradley Alan Trago, Blacksburg, VA (US)

Correspondence Address: BEUSSE WOLTER SANKS MORA & MAIRE, P. A., 390 NORTH ORANGE AVENUE, SUITE 2500, ORLANDO, FL, 32801, US

(21) Appl. No.: 12/043,189

(22) Filed: Mar. 6, 2008

Related U.S. Application Data
(60) Provisional application No. 60/894,503, filed on Mar. 13, 2007.

(30) Foreign Application Priority Data
Mar. 7, 2007 (GB) 0704364.9

(51) Int. Cl. G11B 15/46

(52) U.S. Cl. 242/332.7; 242/390.9

(57) ABSTRACT

A tape drive comprising two motors at least a first of which is an open loop position-controlled motor arranged to provide a controllable torque, two tape spool supports on which spools of tape may be mounted, each spool being drivable by a respective motor, and a controller for controlling the energization of the motors such that the tape may be transported in at least one direction between spools mounted on the spool supports. The controller is arranged to provide a control signal to the first motor to set the tape tension.

### CROSS-REFERENCE TO RELATED APPLICATIONS

This application claims priority to and is based on United Kingdom Application No. 0704364.9 filed Mar. 7, 2007, and incorporated herein by reference in its entirety.

In addition, this application claims priority to and is based on U.S. Provisional Application No. 60/894,503 filed Mar. 13, 2007, and incorporated herein by reference in its entirety.

### BACKGROUND OF THE INVENTION

The present invention relates to a tape drive. Such a tape drive may form part of printing apparatus. In particular, such a tape drive may be used in transfer printers, that is, printers which make use of carrier-supported inks.

In transfer printers, a tape which is normally referred to as a printer tape and carries ink on one side is presented within a printer such that a printhead can contact the other side of the tape to cause the ink to be transferred from the tape on to a target substrate of, for example, paper or a flexible film. Such printers are used in many applications. Industrial printing applications include thermal transfer label printers and thermal transfer coders which print directly on to a substrate such as packaging materials manufactured from flexible film or card.

Ink tape is normally delivered to the end user in the form of a roll wound onto a core. The end user pushes the core on to a tape spool, pulls a free end of the roll to release a length of tape, and then engages the end of the tape with a further spool. The spools may be mounted on a cassette, which can be readily mounted on a printing machine. The printing machine includes a transport means for driving the spools, so as to unwind tape from one spool and to take up tape on the other spool. The printing apparatus transports tape between the two spools along a predetermined path past the printhead.

Known printers of the above type rely upon a wide range of different approaches to the problem of how to drive the tape spools. Some rely upon stepper motors operating in a position control mode to pay out or take-up a predetermined quantity of tape. Other known printers rely on DC motors operating in a torque mode to provide tension in the tape and to directly or indirectly drive the spools. Some known arrangements drive only the spool on to which tape is taken up (the take-up spool) and rely upon some form of “slipping clutch” arrangement on the spool from which tape is drawn (the supply spool) to provide a resistive drag force so as to ensure that the tape is maintained in tension during the printing and tape winding processes and to prevent tape overrun when the tape is brought to rest. It will be appreciated that maintaining adequate tension is an essential requirement for the proper functioning of the printer.

Alternative forms of known printer tape drives drive both the take-up spool and the supply spool. A supply spool motor may be arranged to apply a predetermined drag to the tape, by being driven in the reverse direction to the direction of tape transport. In such an arrangement (referred to herein as “pull-drag”), the motor connected to the take-up spool is arranged to apply a greater force to the tape than the motor connected to the supply spool such that the supply spool motor is overpowered and the supply spool thus rotates in the direction of tape transport. The supply spool drag motor keeps the tape tensioned in normal operation.

In a further alternative arrangement a supply spool motor may be driven in the direction of tape transport such that it contributes to driving the tape from the supply spool to the take-up spool. Such an arrangement is referred to herein as “push-pull”. The take-up motor pulls the tape onto the take-up spool as the tape is unwound by the supply spool motor such that tape tension is maintained. Such a push-pull arrangement is described in our earlier UK Patent No. GB 2,369,602, which discloses the use of a pair of stepper motors to drive the supply spool and the take-up spool. In GB 2,369,602 a controller is arranged to control the energization of the motors such that the tape may be transported in both directions between spools of tape. The tension in the tape being transported between spools is monitored and the motors are controlled to energise both motors to drive the spools of tape in the direction of tape transport.

As a printer gradually uses a roll of tape, the outer diameter of the supply spool decreases and the outer diameter of the take-up spool increases. In slipping clutch arrangements, which offer an essentially constant resistive torque, the tape tension will vary in proportion to the diameter of the spools. Given that it is desirable to use large supply spools so as to minimise the number of times that a tape roll has to be replenished, this is a serious problem particularly in high-speed machines where rapid tape transport is essential. For tape drives that use both a take-up motor and a supply spool motor, the variation in spool diameters can make it difficult to determine the correct drive signal to be supplied to each motor such that tape tension is maintained, and/or that tape is unwound or rewound at the correct rate.

Given these constraints, known printer designs offer a compromise in performance by way of limiting the rate of acceleration, the rate of deceleration, and the maximum speed capability of the tape transport system. Overall printer performance has, as a result, been compromised in some cases.

Known tape drive systems generally operate in one of two manners, that is either continuous printing or intermittent printing. In both modes of operation, the apparatus performs a regularly repeated series of printing cycles, each cycle including a printing phase during which ink is being transferred to a substrate, and a further non-printing phase during which the apparatus is prepared for the printing phase of the next cycle.

In continuous printing, during the printing phase a stationary printhead is brought into contact with a printer tape the other side of which is in contact with a substrate on to which an image is to be printed. The term “stationary” is used in the context of continuous printing to indicate that although the printhead will be moved into and out of contact with the tape, it will not move relative to the tape path in the direction in which tape is advanced along that path. During printing, both the substrate and tape are transported past the printhead, generally but not necessarily at the same speed.

Generally only relatively small lengths of the substrate which is transported past the printhead are to be printed upon, and therefore to avoid gross wastage of tape it is necessary to reverse the direction of travel of the tape between printing operations. Thus in a typical printing process in which the substrate is travelling at a constant velocity, the printhead is extended into contact with the tape only when the printhead is adjacent to regions of the substrate to be printed. Immediately before extension of the printhead, the tape must be accelerated up to, for example, the speed of travel of the substrate. The tape speed must then be maintained at the constant speed of the substrate during the printing phase and, after the printing phase has been completed, the tape must be decelerated and then driven in the reverse direction so that the used region of the tape is on the upstream side of the printhead.

As the next region of the substrate to be printed approaches, the tape must then be accelerated back up to the normal printing speed and the tape must be positioned so that an unused portion of the tape close to the previously used region of the tape is located between the printhead and the substrate when the printhead is advanced to the printing position. Thus very rapid acceleration and deceleration of the tape in both directions is required, and the tape drive system must be capable of accurately locating the tape so as to avoid a printing operation being conducted when a previously used portion of the tape is interposed between the printhead and the substrate.

In intermittent printing, a substrate is advanced past a printhead in a stepwise manner such that during the printing phase of each cycle the substrate and generally but not necessarily the tape, are stationary. Relative movement between the substrate, tape and printhead are achieved by displacing the printhead relative to the substrate and tape. Between the printing phase of successive cycles, the substrate is advanced so as to present the next region to be printed beneath the printhead, and the tape is advanced so that an unused section of tape is located between the printhead and the substrate. Once again rapid and accurate transport of the tape is necessary to ensure that unused tape is always located between the substrate and printhead at a time that the printhead is advanced to conduct a printing operation.

The requirements of high speed transfer printers in terms of tape acceleration, deceleration, speed and positional accuracy are such that many known drive mechanisms have difficulty delivering acceptable performance with a high degree of reliability. Similar constraints also apply in applications other than high-speed printers, for instance drives used in labelling machines, which are adapted to apply labels detached from a label web. Tape drives in accordance with embodiments of the present invention are suitable for use in labelling machines in which labels are detached from a continuous label web which is transported between a supply spool and a take-up spool.

### BRIEF DESCRIPTION OF THE INVENTION

It is an object of embodiments of the present invention to obviate or mitigate one or more of the problems associated with the prior art, whether identified herein or elsewhere. It is a further object of embodiments of the present invention to provide a tape drive which can be used to deliver printer tape in a manner which is capable of meeting the requirements of high speed production lines, although the tape drive of the present invention may of course be used in any other application where similar high performance requirements are demanded.

According to the present invention, there is provided a tape drive comprising two motors at least a first of which is an open loop position-controlled motor arranged to provide a controllable torque, two tape spool supports on which spools of tape may be mounted, each spool being drivable by a respective motor, and a controller for controlling the energization of the motors such that the tape may be transported in at least one direction between spools mounted on the spool supports, wherein the controller is arranged to provide a control signal to the first motor to set the tape tension.

The open loop position-controlled motor can take any suitable form. For example, the open loop position-controlled motor may be a stepper motor. Using a stepper motor in this way may be advantageous given that stepper motors are often cheaper than other torque control motors such as DC motors.

It is preferred that each spool support is coupled to a respective motor by means of a drive coupling providing at least one fixed transmission ratio. Preferably, the ratio of angular velocities of each motor and its respective spool support is fixed. Such an arrangement requires that control of a motor to cause a desired linear tape movement from or to a respective spool takes into account the circumference of that spool.

The drive coupling may comprise a drive belt. Alternatively, as each spool support has a respective first axis of rotation and each motor has a shaft with a respective second axis of rotation, the respective first and second axes may be coaxial. Respective drive couplings may interconnect a respective spool shaft to a respective motor shaft.

The controller may be arranged to control the motor to transport tape in both directions between the spools.

The second motor may take any suitable form. For example, the second motor may be a position-controlled motor.

When the tape is transported in a first direction the first motor maybe arranged to drive a tape spool supplying tape and the second motor maybe arranged to drive a tape spool taking up tape. The first motor may be driven in the opposite direction to the first direction. When tape is transported in a second direction opposite to the first direction, the second motor may be arranged to drive a tape spool supplying tape and the first motor may be arranged to drive a tape spool taking up tape, the first motor being driven in the first direction.

The second motor maybe a torque-controlled motor. Indeed, both motors may be open loop position-controlled motors of any suitable form which are arranged to provide controllable torques.

The, or each, open loop position-controlled motor arranged to provide a controllable torque may comprise an open loop position-controlled motor and an encoder. The encoder may provide a feedback signal indicative of the rotary position of the open loop position-controlled motor. The feedback signal may form an open loop position-controlled motor drive signal.

The controller may be operative to monitor tension in tape being transported between the supply spool and the take up spool, and to control at least one of the motors to maintain tension between predetermined limits.

A tape drive in accordance with certain embodiments of the present invention relies upon both the motors that drive the two tape spools to drive the tape during tape transport. Thus the two motors operate in push-pull mode. This makes it possible to achieve very high rates of acceleration and deceleration. Tension in the tape being transported is determined by control of the drive motors and therefore is not dependent upon any components that have to contact the tape between the take-up and supply spools. Thus a very simple overall mechanical assembly can be achieved. Given that both motors contribute to tape transport, relatively small and therefore inexpensive and compact motors can be used.

A tape drive in accordance with certain other embodiments of the present invention operates in a pull-drag mode in which the motor attached to the spool currently taking up tape drives the spool in the direction of tape transport, whereas the motor coupled to the other spool is driven in a reverse direction in order to tension the tape. In accordance with yet other embodiments of the present invention the tape drive motors may be arranged to operate in a push-pull mode for at least part of a printing cycle and a pull-drag mode for at least another part of the printing cycle.

The actual rotational direction of each spool will depend on the sense in which the tape is wound on each spool. If both spools are wound in the same sense then both spools will rotate in the same rotational direction to transport the tape. If the spools are wound in the opposite sense to one another, then the spools will rotate in opposite rotational directions to transport the tape. In any configuration, both spools rotate in the direction of tape transport. However, according to the operating mode of the supply spool motor, the direction in which it is driven may also be in the same direction as the supply spool (when the motor is assisting in driving the tape, by pushing the tape off the spool) or the supply spool motor may be driven in the opposite direction to that of the supply spool (when the motor is providing drag to the tape in order to tension the tape).

The tape drive may be incorporated in a transfer printer for transferring ink from a printer tape to a substrate, which is transported along a predetermined path adjacent to the printer. The tape drive may act as a printer tape drive mechanism for transporting ink ribbon between first and second tape spools, and the printer further comprising a printhead arranged to contact one side of the ribbon to press an opposite side of the ribbon into contact with a substrate on the predetermined path. There may also be provided a printhead drive mechanism for transporting the printhead along a track extending generally parallel to the predetermined substrate transport path (when the printer is operating in an intermittent printing mode) and for displacing the printhead into and out of contact with the tape. A controller may control the printer ink ribbon and printhead drive mechanisms, the controller being selectively programmable either to cause the ink ribbon to be transported relative to the predetermined substrate transport path with the printhead stationary and displaced into contact with the ink ribbon during printing, or to cause the printhead to be transported relative to the ink ribbon and the predetermined substrate transport path and to be displaced into contact with the ink ribbon during printing.

The drive mechanism may be bi-directional such that tape may be transported from a first spool to a second spool and from the second spool to the first. Typically, unused tape is provided in a roll of tape mounted on the supply spool. Used tape is taken up on a roll mounted on the take-up spool. However, as described above, in order to prevent gross ribbon wastage, after a printing operation the tape can be reversed such that unused portions of the tape may be used before being wound onto the take-up spool.

### BRIEF DESCRIPTION OF THE DRAWINGS

Embodiments of the present invention will now be described, by way of example, with reference to the accompanying drawings in which:

FIG. 1 is a schematic illustration of a printer tape drive system in accordance with an embodiment of the present invention;

FIGS. 2A and 2B are illustrations of a stepper motor;

FIG. 3 is a schematic illustration of drive electronics suitable for driving the stepper motor of FIGS. 2A and 2B;

FIGS. 4A and 4B are illustrations of a stepper motor fitted with an encoder; and

FIG. 5 is a schematic illustration of a system for the controlling the stepper motor of FIGS. 4A and 4B.

### DETAILED DESCRIPTION OF THE INVENTION

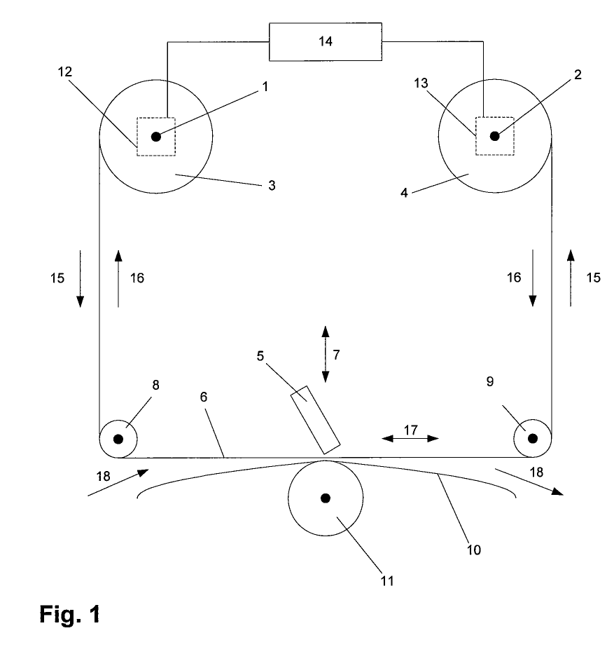

Referring to FIG. 1, this schematically illustrates a tape drive in accordance with the present invention suitable for use in a thermal transfer printer. First and second shafts 1, 2 support a supply spool 3 and a take-up spool 4 respectively. The supply spool 3 is initially wound with a roll of unused tape, and the take-up spool 4 initially does not carry any tape. As tape is used, used portions of the tape are transported from the supply spool 3 to the take-up spool 4. A displaceable printhead 5 is provided, displaceable relative to tape 6 in at least a first direction indicated by arrow 7. Tape 6 extends from the supply spool 3 around rollers 8, 9 to the take-up spool 4. The path followed by the tape 6 between the rollers 8 and 9 passes in front of the printhead 5. A substrate 10 upon which print is to be deposited is brought into contact with the tape 6 between rollers 8 and 9, the tape 6 being interposed between the printhead 5 and the substrate 10. The substrate 10 may be brought into contact with the tape 6 against a platen roller 11.

The supply shaft 1 is driven by a supply motor 12 and the take-up shaft 2 is driven by a take-up motor 13. The supply and take-up motors 12, 13 are illustrated in dashed outline, indicating that they are positioned behind the supply and take-up spools 3, 4. It will however be appreciated that in alternative embodiments of the invention, the spools are not directly driven by the motors. Instead the motor shafts may be operably connected to the respective spools by a belt drive or other similar drive mechanism. In either case, it can be seen that there is a fixed transmission ratio between a motor and its respective spool support.

A controller 14 controls the operation of motors 12, 13 as described in greater detail below. The supply and take-up motors 12, 13 are capable of driving the tape 6 in both directions. Tape movement may be defined as being in the print direction if the tape is moving from the supply spool 3 to the take-up spool 4, as indicated by arrows 15. When tape is moving from the take-up spool 4 to the supply spool 3, the tape may be considered to be moving in the tape reverse direction, as indicated by arrows 16.

When the printer is operating in continuous mode the printhead 5 will be moved into contact with the tape 6 when the tape 6 is moving in the print direction 15. Ink is transferred from the tape 6 to the substrate 10 by the action of the printhead 5. Tape movement may be reversed such that unused portions of the tape 6 are positioned adjacent to the printhead 5 before a subsequent printing operation is commenced.

In the configuration illustrated in FIG. 1, the spools 3, 4 are wound in the same sense as one another and thus rotate in the same rotational direction to transport the tape. Alternatively, the spools 3, 4 may be wound in the opposite sense to one another, and thus must rotate in opposite directions to transport the tape.

As described above, the printer schematically illustrated in FIG. 1 can be used for both continuous and intermittent printing applications. The controller 14 is selectively programmable to select either continuous or intermittent operation. In continuous applications, the substrate 10 will be moving continuously. During a printing cycle, the printhead 5 will be stationary but the tape will move so as to present fresh tape to the printhead 5 as the cycle progresses. In contrast, in intermittent applications, the substrate 10 is stationary during each printing cycle, the necessary relative movement between the substrate 10 and the printhead 5 being achieved by moving the printhead 5 parallel to the tape 6 and substrate 10 in the direction of arrow 17 during the printing cycle. In such a case, the roller 11 is replaced with a flat print platen (not shown) against which the printhead 5 presses the ribbon 6 and substrate 10. In both applications, it is necessary to be able to rapidly advance and return the tape 6 between printing cycles so as to present fresh tape to the printhead and to minimise tape wastage. Given the speed at which printing machines operate, and that fresh tape 6 should be present between the printhead 5 and substrate 10 during every printing cycle, it is necessary to be able to accelerate the tape 6 in both directions at a high rate and to accurately position the tape relative to the printhead. In the arrangement shown in FIG. 1 it is assumed that the substrate 10 will move only to the right as indicated by arrows 18. However, the apparatus can be readily adapted to print on a substrate travelling to the left (that is, in the opposite direction) in FIG. 1.

One of the motors 12, 13 is a stepper motor fitted with an encoder monitoring its position. Such a stepper motor and encoder combination is able to provide torque control. The encoder is directly driven by the stepper motor and provides a feedback signal indicative of the output rotary position of the stepper motor. Any form of encoder may be used. For example, the encoder may comprise an optical disc attached to the motor shaft such that the disc rotates with the motor shaft, and optical sensing means detect rotation of the disc.

The term “encoder” is used to refer to any form of angular position sensing device, such as an optical encoder, magnetic encoder, resolver, capacitive encoder or any other form of position sensing device.

When operated normally a stepper motor is driven by a stepper drive circuit so that the motor's shaft position is driven by a drive signal comprising a series of pulses. The stepper motor is designed to advance its rotary position by a predetermined amount (known as a step) each time a pulse is received. The drive signal may comprise a continuous series of pulses. For such a drive signal, the stepper motor is arranged to rotate by one step for each pulse, such that if the pulse repetition frequency is sufficiently high and the angular step size is sufficiently small, the motor output shaft rotates substantially continuously. The pulse repetition frequency of the drive signal determines the angular velocity of the stepper motor output shaft.

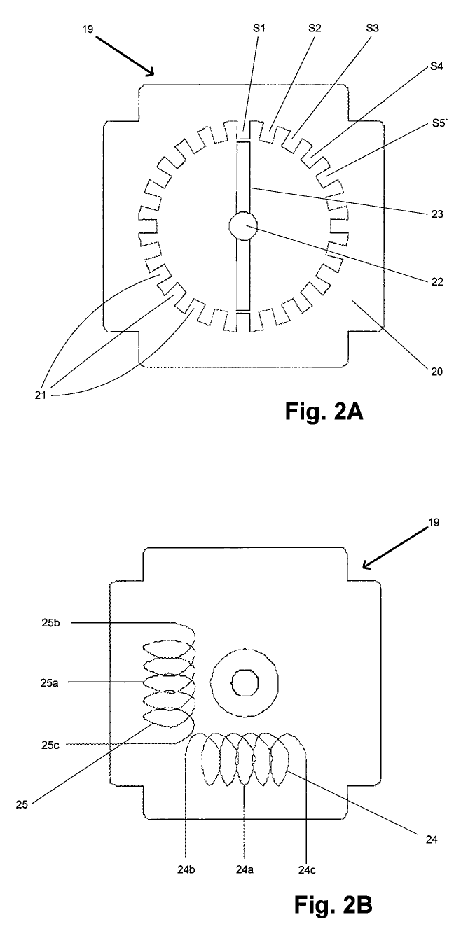

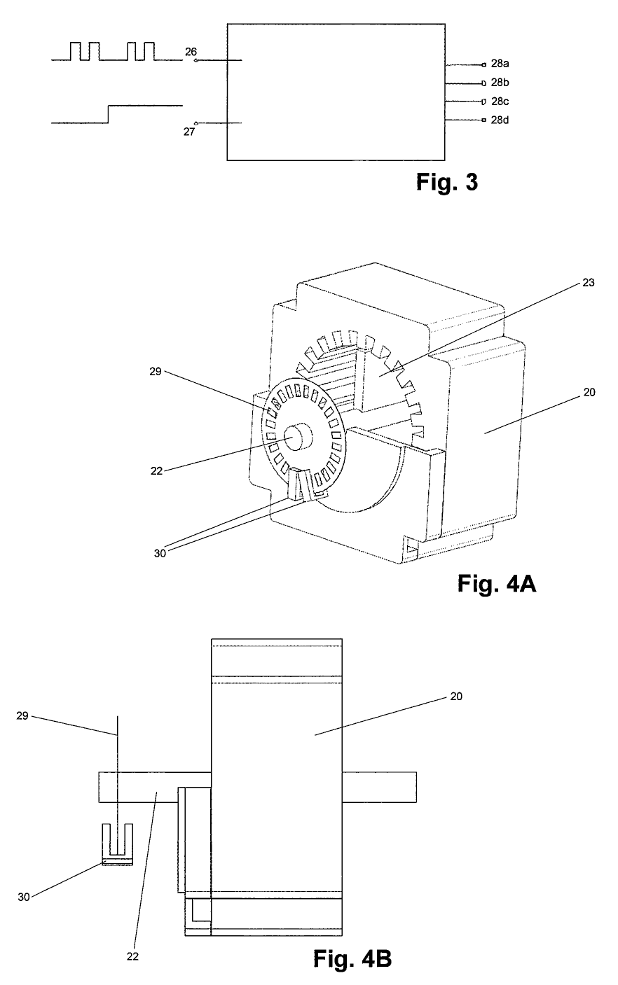

FIGS. 2A and 2B schematically illustrate the construction of a stepper motor 19. It can be seen that the stator 20 is provided with a plurality of teeth 21. A motor shaft 22 is connected to a rotor 23. The rotor 23 is caused to move by appropriate energization of two coils 24, 25. Energization of the coils 24, 25 causes particular teeth 21 of the stator 20 to be energised, causing the rotor 23 and motor shaft 22 to turn. It can be seen that each coil has three connections. The coil 24 has three connections 24a, 24b, 24c. The coil 25 has three connections 25a, 25b, 25c. Conventionally, the stepper motor 19 is driven by appropriate drive electronics shown in FIG. 3. It can be seen that the drive electronics takes as input a pulse train 26 indicating a step rate, and a signal 27 indicating a direction in which the motor is to move. The drive electronics provides four outputs 28a, 28b, 28c, 28d which are connected to the connections 24b, 24c, 25b, 25c provided by the coils 24, 25.

Four different command signals are provided to the stepper motor by appropriate energization of the coils, as shown in Table 1:

TABLE 1

| | Coil 24 | | | Coil 25 | | |
|---|---|---|---|---|---|---|
| Step | 24a | 24b | 24c | 25a | 25b | 25c |
| S1 | + | − | | + | | − |
| S2 | + | | − | + | | − |
| S3 | + | | − | + | − | |
| S4 | + | − | | + | − | |

Where a cell of Table 1 is empty, no voltage is provided to the appropriate connection of the respective coil. Where a cell of Table 1 shows a “+”, a positive voltage is provided, while where a cell of Table 1 shows a “−”, a negative voltage is provided. It can be seen that a positive voltage is always provided to the connections 24a, 24b, while a negative voltage is, for any particular control signal provided to one of the other connections of each coil.

Referring back to FIG. 2A, it can be seen that the rotor 23 is currently aligned with a position denoted S1. To maintain the motor in this position, it can be seen from Table 1 that a voltage is applied across the connections 24a, 24b of the coil 24, and across the connections 25a, 25c of the coil 25. To cause the rotor 23 to move the position denoted S2, a voltage is applied across the connections 24a, 24c of the coil 24 and across the connections 25a, 25c of the coil 25. The motor is similarly controlled to cause the rotor 23 to move to positions denoted S3 and S4 in FIG. 2A. It can also be seen that a position following the position S4 (in the clockwise direction) is denoted S1′, indicating that the drive signal association with step S1 in Table 1 is provided to cause the rotor to move to the position denoted S1′. The sequence of control signals repeats for subsequent positions of the stepper motor.

From the preceding description it will be appreciated that the drive electronics of FIG. 3 can provide appropriate signals to the coils 24, 25 to cause the rotor 23 to rotate.

As described above, one of the supply motor 12 and the take-up motor 13 is a stepper motor of the type illustrated in FIGS. 2A and 2B. However, as indicated, the stepper motor 19 is provided with an encoder configured to monitor the motor's rotary position. A suitable arrangement is shown in FIGS. 4A and 4B, where FIG. 4A is a perspective cutaway view of the arrangement and FIG. 4B is a cutaway side view. Referring to FIG. 4A, it can be seen that an encoder disc 29 is attached to the motor shaft 22. Sensors 30 optically detect motion of the encoder disc 29 by detecting apertures within the encoder disc 29 as it moves rotationally. Movement of the motor shaft 22 is consequently detected.

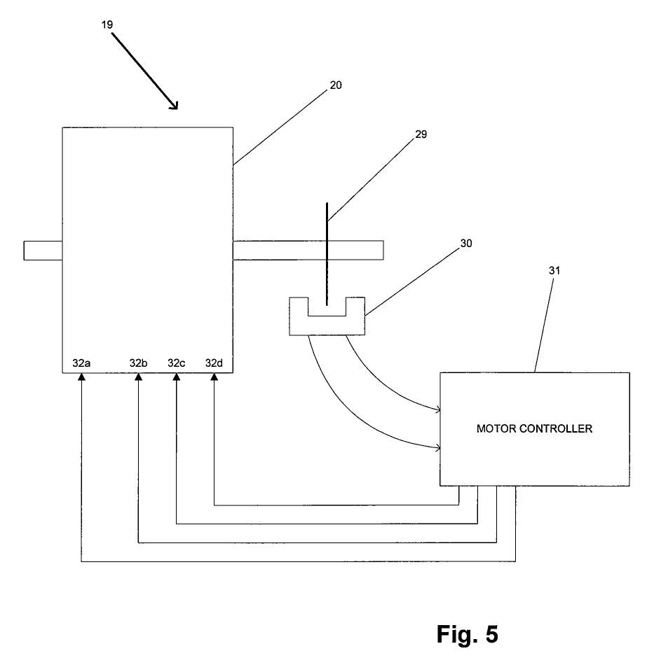

Rotation of the motor is controlled with reference to signals provided by the sensors 30. Referring to FIG. 5, it can be seen that signals from the sensors 30 are input to a motor controller 31. The motor controller 31 controls the stepper motor 19 and replaces the drive electronics shown in FIG. 3. Signals received by the motor controller 31 are processed to generate a control signal which is provided to the stepper motor 19 as shown. It can be seen that the control signal is provided over four output lines 32a, 32b, 32c, 32d which correspond to the outputs 28a, 28b, 28c, 28d of the drive electronics of FIG. 3. The motor controller 31 is configured to process the signals received from the sensors 31 and determine a current position of the motor shaft 22. From this determined position, a control signal corresponding to the next step position of the motor is generated. That is, if the motor shaft 22 is in a position associated with a step denoted S1, the control signal associated with a step denoted S2 is generated, and so on. In this way, the motor controller 31 provides closed loop control for the stepper motor, in which the motor is always controlled to move to the next rotational position.

It will be appreciated that any suitable control scheme can be used. For example, the motor can be energised so as to cause the motor shaft 22 to move to the position denoted S2 when the rotor 23 is positioned slightly clockwise or slightly anticlockwise of the position denoted S1.

Effective torque control can therefore be achieved by controlling the current supplied to the motor in exactly the same way as for a DC torque motor. Advantageously, by using stepper motors in place of DC motors to provide torque control the overall cost of the tape drive can be reduced as stepper motors typically cost less than DC motors for a comparable torque range. Furthermore, stepper motors used in this way can effectively use the whole torque range of the stepper motor, whereas an open loop torque-controlled motor typically must be limited to only a portion of the potential torque range in order to prevent stalling.

As described above one of the motors 12, 13 is provided in the form of a stepper motor provided with an encoder so as to allow torque control. The other motor is a position-controlled motor.

A position-controlled motor comprises a motor controlled by a demanded output rotary position. An example of a position-controlled motor is a stepper motor 19 as described with reference to FIGS. 2A and 2B which operates as an open loop position-controlled motor. The output position of the rotor 22 in the stepper motor of FIGS. 2A and 2B may be varied on demand, or the output rotational velocity may be varied by control of the speed at which the demanded output rotary position changes.

An example of closed loop position-controlled motor is a DC motor provided with an encoder. The output from the encoder provides a feedback signal from which an error signal can be generated when the feedback signal is compared to a demanded output rotary position, the error signal being used to drive the motor to minimise the error.

A torque-controlled motor is a motor that is controlled by a demanded output torque. An example of a torque-controlled motor has been provided above. An alternative example of a torque-controlled motor is a DC motor without encoder feedback (or a DC motor having an encoder, but the encoder signal is temporarily or permanently not used).

In the present context the term “DC motor” is to be interpreted broadly as including any form of motor that can be driven to provide an output torque, such as a brushless DC motor, a brushed DC motor, an induction motor or an AC motor. A brushless DC motor comprises any form of electronically commutated motor with integral commutation sensor. Similarly, the term stepper motor is to be interpreted broadly as including any form of motor that can be driven by a pulsed drive signal, each pulse indicating a further required change of rotary position.

For both the supply and the take-up motors, the drive signal supplied to the motor is varied as the diameter of the supply spool and the take-up spool vary. Determining the appropriate motor drive signal requires that the spool diameters be determined in order that the demanded motor torque or the demanded motor position for the printing operation can be adjusted accordingly. This is because for a torque-controlled motor, the applied torque determines the tension within the tape. The contribution to tape tension made by a torque-controlled motor is equal to the tangential force applied to the tape by the motor torque at the outer edge of the spool. The tension is therefore proportional to the radius of the spool. Similarly, for a position-controlled motor, the larger the spool radius is, the larger any linear motion of the tape will be for a given angular rotation of the spool.

One known method of monitoring the diameter of a spool of tape is based upon optical sensing comprising at least one optical emitter and one optical detector. The optical emitter and detector are arranged such that as the diameter of the spool changes, the spool blocks that signal from the emitter to the detector, which may be detected. Such an optical spool diameter monitoring technique is disclosed in GB 2,369,602.

An alternative method for determining tape spool diameter is disclosed in GB 2,298,821. Here, tape is passed around an idler roller of known diameter. The idler roller is provided with an anti-slip coating to prevent slippage occurring between the tape and the idler roller when the tape is moved. The outer diameter of the idler roller is known. Rotation of the idler roller is monitored. This is achieved by providing the idler roller with a magnetic disc having a north and south pole. Rotation of the idler roller can then be detected by an appropriate magnetic sensor. By detecting rotation of the idler roller of known diameter and knowing a number of steps through which a stepper motor has turned the diameter of a spool of tape associated with the stepper motor can be determined. It will be appreciated that other sensing systems, such as optical sensing systems can also suitably be used.

In accordance with certain embodiments of the present invention tape tension is monitored in order to provide a feedback signal allowing the drive signal provided to one or both motors to be varied in order to control the actual tension in the tape. This is different to and more accurate than only varying the drive signal in accordance with a demanded tape tension, which may differ from the actual tape tension due to factors external to the motors, for instance the tape stretching over time.

Where appropriate, any suitable method of measuring the tension of a tape may be used, including directly monitoring the tension through the use of a component that contacts the tape and indirect tension monitoring. Direct tension monitoring includes, for example, a resiliently biased roller or dancing arm that is in contact with the tape, arranged such that a change in tape tension causes the roller or dancing arm to move position, the change in position being detectable using, for example a strain gauge. Alternatively, tape may be passed around a roller which bears against a load cell. Tension in the tape affects the force applied to the load cell, such that the output of the load cell provides an indication of tape tension.

Indirect tension monitoring includes methods in which the current supplied to a torque-controlled motor is monitored. If the tape tension changes, the motor must automatically adjust its output torque to counteract the tension change (in order to prevent rotation of the motor shaft being caused by a change in tape tension). A change in torque applied by a motor may be detected by a measuring the consequent change in current supplied to the motor. Alternatively, a method suitable for monitoring tension in a tape drive using two stepper motors is described in our earlier UK Patent No. GB 2,369,602.

Referring again to FIG. 1, the tape drive is now described such that the torque-controlled stepper motor is the supply motor 12 and the position-controlled motor is the take-up motor 13.

When the tape is travelling in the print direction, the tape drive operates in a pull-drag mode. That is, the torque-controlled stepper supply motor provides a drag force acting on the tape in order to keep the tape tensioned. The torque controlled stepper motor is driven in the opposite direction to the direction of tape transport, however the force applied to the tape is chosen such that the position-controlled motor is able to overpower the torque-controlled stepper motor such that the supply spool rotates in the direction of tape transport. Tension in the tape can be controlled by controlling the current supplied to the stepper supply motor. The take-up position control motor is driven at the appropriate angular velocity in order to drive the tape past the printhead at the correct speed.

When the tape is travelling in the tape reverse direction, the tape drive operates in a push-pull mode. The torque-controlled stepper supply motor 12 applies a pulling force to the tape, and is responsible for setting the tension within the tape by appropriate control of the current supplied to the stepper supply motor. The position-controlled take-up motor is driven to assist in transporting the tape, by being driven in the direction of tape transport; however, the position-controlled take-up motor is arranged to rotate less fast than the supply motor so that the net effect is that the tape remains tensioned between the spools.

For both motors, the drive signal supplied to the motor is varied as the diameter of the supply spool and the take-up spool vary. Determining the appropriate motor drive signal requires that the spool diameters are measured as described above in order that the demanded motor torque or the demanded motor position for the printing operation can be adjusted accordingly.

Although the embodiment of the invention described above is such that the supply motor is a torque controlled stepper motor, it will be appreciated that that the take-up motor could similarly be a torque controlled stepper motor, with the take-up motor being a position controlled motor. Similarly, a torque controlled stepper motor can be used to drive one spool while any suitable drive means is provided to drive the other spool.

It will be appreciated that in accordance with the present invention a stepper motor controlled to provide a controlled torque to a tape within a tape drive can be used to replace a conventional form of torque motor (such as an open loop DC motor) wherever such a torque motor is used within known tape drives. This includes tape drives for which both the supply and take-up motors comprise DC motors (either or both DC motor may be replaced).

As noted above, tape drives in accordance with embodiments of the present invention may be used in thermal transfer printers of the type described above. Tape drives in accordance with embodiments of the present invention may be advantageously used in a thermal transfer over printer, such as may be used within the packaging industry, for instance for printing further information such as dates and bar codes over the top of pre-printed packaging (such as food bags).

Additionally, tape drives in accordance with embodiments of the present invention may be used in other applications, and provide similar advantages to those evident in thermal transfer printers, for instance fast and accurate tape acceleration, deceleration, speed and positional accuracy.

An alternative application where such tape drives may be applied is in labelling machines, which are adapted to apply labels detached from a continuous tape (alternatively referred to as a label web). Tape drives in accordance with embodiments of the present invention are suitable for use in labelling machines in which a label carrying web is mounted on a supply. Labels are removed from the web, and the web is driven onto a take-up spool.

In general, tape drives in accordance with embodiments of the present invention may be used in any application where there is a requirement to transport any form of tape, web or other continuous material from a first spool to a second spool.

Further modifications and applications of the present invention will be readily apparent to the appropriately skilled person from the teaching herein, without departing from the scope of the appended claims.

What is claimed is:

1. A tape drive comprising two motors at least a first of which is an open loop position-controlled motor arranged to provide a controllable torque, two tape spool supports on which spools of tape may be mounted, each spool being drivable by a respective motor, and a controller for controlling the energization of the motors such that the tape may be transported in at least one direction between spools mounted on the spool supports, wherein the controller is arranged to provide a control signal to the first motor to set the tape tension.

2. A tape drive according to claim 1, wherein the controller is arranged to control the motors to transport tape in both directions between the spools.

3. A tape drive according to claim 1, wherein the second motor is a position-controlled motor.

4. A tape drive according to claim 3, wherein when the tape is transported in a first direction the first motor is arranged to drive a tape spool supplying tape and the second motor is arranged to drive a tape spool taking up tape, the first motor being driven in the opposite direction to the first direction.

5. A tape drive according to claim 4, wherein when the tape is transported in a second direction opposite to the first direction, the second motor is arranged to drive a tape spool supplying tape and the first motor is arranged to drive a tape spool taking up tape, the first motor being driven in the first direction.

6. A tape drive according to claim 1, wherein the second motor is a torque-controlled motor.

7. A tape drive according to claim 6, wherein both motors are open loop position control motors arranged to provide controllable torques.

8. A tape drive according to claim 1, wherein each open loop position control motor is a stepper motor.

9. A tape drive according to claim 1, wherein each open loop position-controlled motor arranged to provide a controllable torque comprises a open loop position-controlled motor and an encoder, the encoder providing a feedback signal indicative of the rotary position of the open loop position control motor, the feedback signal forming an open loop position control motor drive signal.

10. A tape drive according to claim 1, wherein the controller is operative to monitor tension in a tape being transported between a supply spool and a take-up spool and to control at least one of the motors to maintain the monitored tension between predetermined limits.

11. A tape drive according to claim 1, wherein each spool support is coupled to a respective motor by means of a drive coupling providing at least one fixed transmission ratio.

12. A tape drive according to claim 11, wherein the drive coupling comprises a drive belt.

13. A tape drive according to claim 1, wherein each spool support has a respective first axis of rotation, each motor has a shaft with a respective second axis of rotation, and the respective first and second axes are co axial.

14. A tape drive according to claim 11, wherein each spool support has a respective spool shaft, each motor has a respective motor shaft and respective drive couplings interconnect a respective spool shaft to a respective motor shaft.

15. A tape drive according to claim 1 incorporated in a thermal transfer printer.

16. A tape drive according to claim 15, wherein the printer is configured to transfer ink from a printer ribbon to a substrate which is transported along a predetermined path adjacent to the printer, the tape drive acting as a printer ribbon drive mechanism for transporting ribbon between first and second ribbon spools, and the printer further comprising a printhead arranged to contact one side of the ribbon to press an opposite side of the ribbon into contact with a substrate on the predetermined path.

17. A tape drive according to claim 16, wherein the printer further comprises a printhead drive mechanism for transporting the printhead along a track extending generally parallel to the predetermined substrate transport path and for displacing the printhead into and out of contact with the ribbon, and a printer controller controlling the printer ribbon and printhead drive mechanisms.

18. A tape drive according to claim 17, wherein the printer controller is selectively programmable either to cause the ribbon to be transported relative to the predetermined substrate transport path with the printhead stationary and displaced into contact with the ribbon during printing, or to cause the printhead to be transported relative to the ribbon and the predetermined substrate transport path and to be displaced into contact with the ribbon during printing.

19. A tape drive according to claim 15, wherein the printer is a thermal transfer over printer.

20. A method for controlling a tape drive comprising two motors at least first of which is an open loop position control motor arranged to provide a controllable torque, two tape spool supports on which spools of tape may be mounted, each spool being drivable by a respective motor, and a controller for controlling the energization of the motors such that the tape may be transported in at least one direction between spools mounted on the spool supports, wherein the controller provides a control signal to the open loop position control motor to set the tape tension.
